(19) United States
(12) Patent Application Publication
(10) Pub. No.: US 2013/0034641 A1
(43) Pub. Date: Feb. 7, 2013

(54) Non-Rigid Food Packaging Product with Fill Line

(71) Applicant: MOM Brands Company, Minneapolis, MN (US)

(72) Inventor: Kevin S. McFadden, Lakeville, MN (US)

(73) Assignee: MOM Brands Company, Minneapolis, MN (US)

(21) Appl. No.: 13/648,430

(22) Filed: Oct. 10, 2012

Related U.S. Application Data
(62) Division of application No. 12/365,425, filed on Feb. 4, 2009.

(51) Int. Cl. B65D 81/00; A23L 2/39; A23L 1/168

(52) U.S. Cl. 426/389

(57) ABSTRACT

This disclosure describes a food packaging product constructed of a non-rigid material. Initially, an interior cavity of the food packaging product contains a food product. To prepare the food product for consumption, a consumer opens the food packaging product and empties the food product into a container. After emptying the food product into the container, the consumer pours a liquid into the interior cavity of the food packaging product such that a top surface of the liquid is substantially level with a fill line marked on the food packaging product. The fill line is visible on the interior cavity of the food packaging product. The material of the food packaging product prevents the liquid from leaking out of the interior cavity of the food packaging product. The consumer then pours the liquid into the container, thereby creating a mixture of the food product and the liquid.

### BACKGROUND

Many types of food products are distributed to consumers in dehydrated or semi-dehydrated form. To prepare such a food product for eating or drinking, a consumer must mix the food product with a liquid, such as water or milk. Frequently, the consumer must add a relatively precise amount of the liquid to the food product to ensure the recommended consistency and flavor of the food product when the food product is ready for consumption. The need to add relatively precise amounts of liquids to dehydrated or semi-dehydrated food products generally necessitates the use of a separate measuring device, such as a measuring cup. Storing separate measuring devices may be inconvenient.

### SUMMARY

This disclosure describes a food packaging product constructed of a non-rigid material. Initially, an interior cavity of the food packaging product contains a food product. To prepare the food product for consumption, a consumer opens the food packaging product and empties the food product into a container. After emptying the food product into the container, the consumer pours a liquid into the interior cavity of the food packaging product such that a top surface of the liquid is substantially level with a fill line marked on the food packaging product. The fill line is visible on the interior cavity of the food packaging product. The material of the food packaging product prevents the liquid from leaking out of the interior cavity of the food packaging product. The consumer then pours the liquid into the container, thereby creating a mixture of the food product and the liquid.

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

### BRIEF DESCRIPTION OF THE DRAWINGS

FIG. 1 illustrates a first example food packaging product.

FIG. 2 illustrates a second example food packaging product.

FIG. 3 illustrates a side view of a first example material of which the food packaging product is constructed.

FIG. 4 illustrates a side view of a second example material of which the food packaging product is constructed.

FIG. 5 illustrates a side view of a third example material of which the food packaging product is constructed.

FIG. 6 illustrates an example process of using the food packaging product.

FIG. 7 illustrates an example process of manufacturing the food packaging product.

FIG. 8 illustrates a perspective view of the example food packaging product.

### DETAILED DESCRIPTION

As briefly described above, the present disclosure is directed to a food packaging product. The present disclosure describes the food packaging product with reference to the attached figures. Numbers in the present disclosure refer to corresponding numbers in the attached figures. It will be appreciated that the figures are provided for purposes of explanation only and do not represent a sole way of implementing the technologies of the present disclosure.

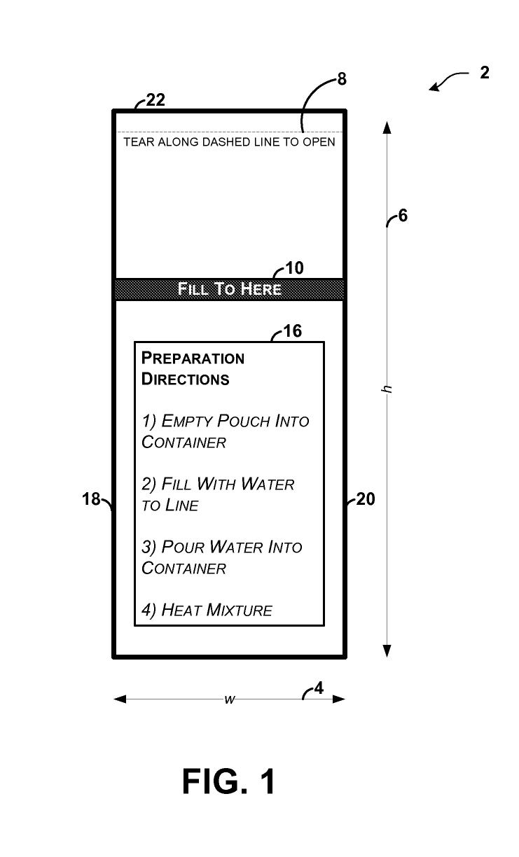

FIG. 1 illustrates an example food packaging product 2. The food packaging product 2 comprises a front member and a rear member. When the food packaging product 2 is empty, the front member and the rear member are substantially flat. The front member of the food packaging product 2 is substantially the same size and shape as the rear member of the food packaging product 2. The front member of the food packaging product 2 is deposed in front of the rear member of the food packaging product 2. For this reason, only an outer surface of one of the members of the food packaging product 2 is shown in FIG. 1. The surface shown in the example of FIG. 1 may be the outer surface of either the front member of the food packaging product 2 or the rear member of the food packaging product 2.

When a consumer receives the food packaging product 2, the front member of the food packaging product 2 is attached to the rear member of the food packaging product 2 only at the edges of the food packaging product 2. The food packaging product 2 defines an interior cavity because the front member of the food packaging product 2 and the rear member of the food packaging product 2 are only attached at their edges. The interior cavity of the food packaging product 2 is slightly less wide than the width of the food packaging product 2 and slightly less high than the height of the food packaging product 2. In the example of FIG. 1, a width axis 4 indicates the width dimension of the food packaging product 2 and a height axis 6 indicates the height dimension of the food packaging product 2.

When the consumer receives the food packaging product 2, the interior cavity of the food packaging product 2 contains a food product that should be mixed with a liquid before consumption. As used in this disclosure, the term “food product” means food or beverage. For example, the food product may be instant oatmeal. Other example types of food products that should be mixed with a liquid before consumption include, but are not limited to, pasta sauces, seasoning mixes, powdered drink mixes (e.g., hot chocolate, sports drinks, lemonade, etc.), concentrated drink mixes, condensed soup, dehydrated soup, powdered cheese, gravy mixes, dehydrated or condensed milk, and so on.

The food packaging product 2 may be a variety of different sizes as appropriate for the food product stored within the food packaging product 2. For example, the food product is instant oatmeal and the food packaging product 2 is 3.125 inches wide and 7.00 inches high. In this example, the height of the food packaging product 2 is approximately 2.24 times greater than the width of the food packaging product 2. Furthermore, in this example, the size of the food packaging product 2 allows the interior cavity of the food packaging product 2 to contain a single 43 gram serving of instant oatmeal. It should be appreciated that the interior cavity of the food packaging product 2 may contain a wide variety of different amounts of the food product. For example, the interior cavity of the food packaging product 2 may contain an amount of the food product that ranges from 28 grams to 46 grams.

A tear line 8 is visibly marked on an outer surface of the food packaging product 2. The tear line 8 indicates a line along which a consumer is to open the food packaging product 2. When the consumer wants to prepare the food product in the food packaging product 2, the consumer tears the food packaging product 2 open along the tear line 8. The tear line 8 may be marked on the outer surface of the food packaging product 2 in a variety of ways. For example, the tear line 8 may be printed on the outer surface of the food packaging product 2. In another example, the tear line 8 may be stamped into the outer surface of the food packaging product 2.

In addition, a fill line 10 is visibly marked on the illustrated surface of the food packaging product 2. To prepare the food product in the food packaging product 2, the consumer empties the food product from the food packaging product 2 into a container. The consumer then pours a recommended volume of a liquid into the interior cavity of the food packaging product 2. The recommended volume of the liquid is a volume of the liquid that should be added to the food product to properly prepare the food product. The recommended volume of the liquid is less than a volume of the interior cavity. The liquid may be a variety of different types of liquid, as appropriate for the food product in the food packaging product 2. For example, the liquid may be water, milk, juice, syrup, vegetable oil, olive oil, cooking oil, liquid butter, and/or other types of liquid.

The fill line 10 is marked on the food packaging product 2 such that when the consumer pours the liquid into the interior cavity of the food packaging product 2 such that a top surface of the liquid is substantially level with the fill line 10, the recommended volume of the liquid is in the interior cavity of the food packaging product 2. In a first example, the recommended volume of the liquid needed to prepare the food product may be 500 milliliters. In this first example, when the top surface of the liquid is approximately level with the fill line 10, there are 500 milliliters of the liquid in the interior cavity of the food packaging product 2. In a second example, the food packaging product 2 is designed to contain a single serving of instant oatmeal (e.g., 43 grams). In this second example, the recommended volume of water is ⅔ U.S. cups (i.e., approximately 158 milliliters). Consequently, in this second example, when the top surface of the water is approximately level with the fill line 10, there are approximately 158 milliliters of water in the interior cavity of the food packaging product 2. It will be appreciated that the recommended volume of water may be a variety of different volumes. For instance, the recommended volume of water may be ½ cup. The recommended volume of liquid may depend on the type and volume of the food product. After pouring the liquid into the interior cavity of the food packaging product 2, the consumer pours the liquid out of the food packaging product 2 into the container, thereby creating a mixture of the food product and the liquid.

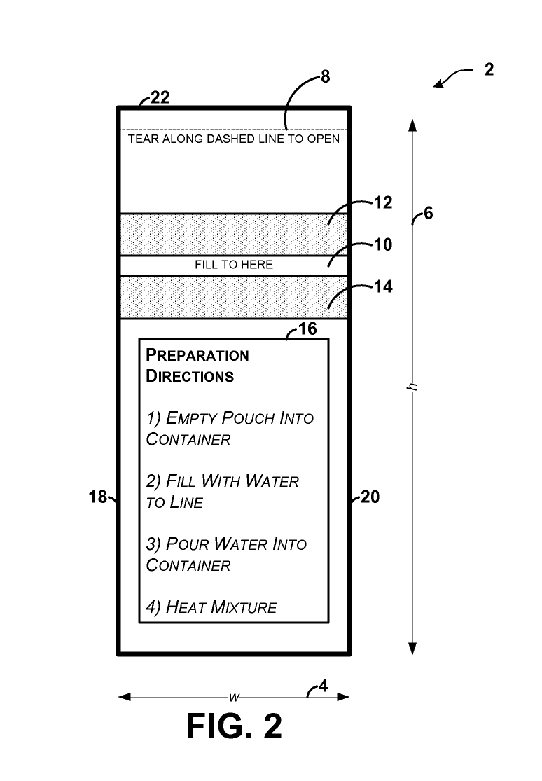

The fill line 10 may be marked on the food packaging product 2 in a variety of ways. In the example of FIG. 1, the fill line 10 is printed as single line on the food packaging product 2. FIG. 2 illustrates a second example food packaging product that is similar to the food packaging product 2 illustrated in the example of FIG. 1. However, in the example of FIG. 2, the fill line 10 is marked as non-printed line adjacent to two printed areas 12 and 14. It should be understood that in other instances the fill line 10 may be marked as a solid printed line, a dashed printed line, a dotted printed line, or another type of line.

In addition to the tear line 8 and the fill line 10, other information may be printed on the food packaging product 2. In the example of FIG. 1, a set of directions 16 is printed on the food packaging product 2. The directions 16 indicate how the consumer is to prepare the food product. In the example of FIG. 1, the directions 16 indicate that the consumer is to:
i. Empty the content of the pouch (i.e., the food packaging product 2) into a container.
ii. Fill the pouch with water to fill line.
iii. Pour water into container.
iv. Heat mixture.

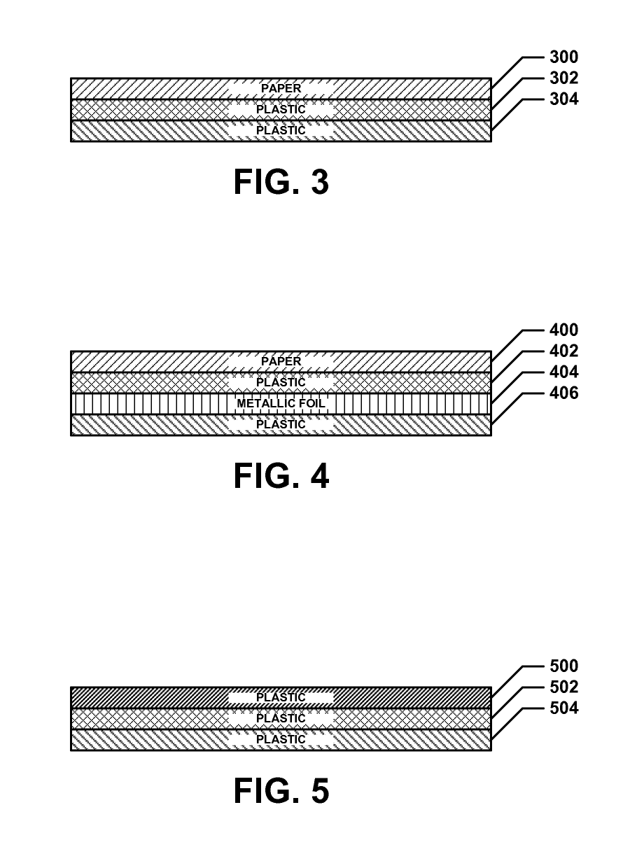

The food packaging product 2 is constructed of one or more non-rigid materials. FIG. 3 illustrates a first example material of which the food packaging product 2 may be constructed. As illustrated in the example of FIG. 3, the food packaging product 2 may be constructed of an outer paper layer 300, an intermediate plastic layer 302, and an inner plastic layer 304. In the example of FIG. 3, the outer paper layer 300 forms an outer surface of the food packaging product 2. The outer paper layer 300 provides a surface on which the tear line 8, the fill line 10, and the directions 16 may be printed. In one instance, the outer paper layer 300 is 25# Natural Kraft Paper. The outer paper layer 300 is laminated to all of the outer surface of the intermediate plastic layer 302. The intermediate plastic layer 302 may be a clear plastic, such as polyvinylidene chloride (PVDC). The intermediate plastic layer 302 has barrier properties. In other words, the intermediate plastic layer 302 acts to prevent elements from the external environment (e.g., moisture, insects, mold spores, bacteria, etc.) from entering the interior cavity of the food packaging product 2. In addition, the intermediate plastic layer 302 is substantially impermeable to the liquid. In one instance, the intermediate plastic layer 302 is a 6# PVDC plastic layer. The inner plastic layer 304 is laminated to all of the inner surface of the intermediate plastic layer 302 and serves as a lining of the interior cavity of the food packaging product 2. Because the inner plastic layer 304 serves as the lining of the interior cavity of the food packaging product 2, the inner plastic layer 304 must be safe for direct contact with the food product. When the inner plastic layer 304 is folded such that the inner plastic layer 304 is in contact with itself, the touching parts of the inner plastic layer 304 seal to one another when exposed to heat. In this way, the inner plastic layer 304 acts as a sealant layer. For instance, the inner plastic layer 304 may be polyethylene (PE). In this instance, the inner plastic layer 304 may be 9# polyethylene plastic.

FIG. 4 illustrates a second example material of which the food packaging product 2 may be constructed. As illustrated in the example of FIG. 4, the food packaging product 2 may be constructed of an outer paper layer 400, an intermediate plastic layer 402, an intermediate metallic foil layer 404, and an inner plastic layer 406. In the example of FIG. 4, the outer paper layer 400 may be similar to the outer paper layer 300 illustrated in the example of FIG. 3, the intermediate plastic layer 402 may be similar to the intermediate plastic layer 302 illustrated in the example of FIG. 3, and the inner plastic layer 406 may be similar to the inner plastic layer 304 illustrated in the example of FIG. 3. The outer paper layer 400 is laminated to all of the intermediate plastic layer 402. In the example of FIG. 4, the intermediate metallic foil layer 404 is interposed between the intermediate plastic layer 402 and the inner plastic layer 406. The intermediate metallic foil layer 404 may provide additional barrier properties to the food packaging product 2. In addition, the intermediate metallic foil layer 404 may improve the aesthetic appeal of the food packaging product 2.

FIG. 5 illustrates a third example material of which the food packaging product 2 may be constructed. As illustrated in the example of FIG. 5, the food packaging product 2 may be constructed of an outer plastic layer 500, an intermediate plastic layer 502, and an inner plastic layer 504. In the example of FIG. 5, the intermediate plastic layer 502 and the inner plastic layer 504 may be similar in purpose and construction to the intermediate plastic layer 302 and the inner plastic layer 304 illustrated in the example of FIG. 3. The outer plastic layer 500 is laminated to all of the outer surface of the intermediate plastic layer 502. The outer plastic layer 500 is a type of plastic on which the tear line 8, the fill line 10, and the directions 16 may be printed. The outer plastic layer 500 may be transparent, semi-transparent, or opaque. In instances in which the outer plastic layer 500 is opaque, a fill line may be marked at an appropriate position on the inner surface of the outer plastic layer 500 such that the fill line is visible from the interior cavity of the food packaging product 2.

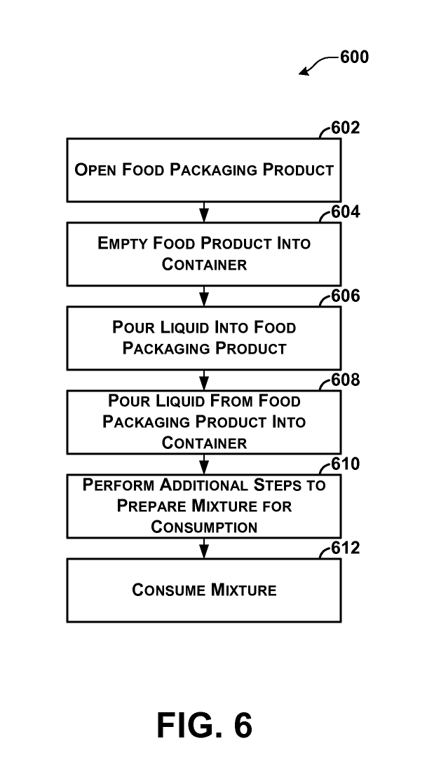

FIG. 6 illustrates an example process 600 of using the food packaging product 2. It should be understood that process 600 is described for purposes of explanation only. Other processes of using the food packaging product 2 may be possible and within the scope of this disclosure. For instance, other processes of using the food packaging product 2 may involve more or fewer steps than process 600. In other instances, other processes of using the food packaging product 2 may involve the same steps as process 600, but the steps may be in a different sequence.

Initially, the consumer opens the food packaging product 2 by tearing the food packaging product 2 along the tear line 8 (602). It should be understood that, in addition to or as an alternative to tearing, the consumer could open the food packaging product in a variety of ways. The ways in which the consumer may open the food packaging product 2 may depend on how the food packaging product 2 is constructed. For example, the consumer may open the food packaging product 2 using scissors, a zip seal, pulling the front member and the rear member apart, unfolding, and so on.

After the consumer has opened the food packaging product 2, the consumer empties a food product contained in the interior cavity of the food packaging product 2 into a container (604). Depending on the type of the food product, the consumer may empty the food product into the container in a variety of ways. For example, if the food product is a powder, a low-viscosity liquid, or a dry cereal, the consumer may empty the food product into the container by pouring the food product out of the interior cavity of the food packaging product 2 into the container. In another example, if the food product is a high-viscosity liquid, such as a condensed soup or a semi-liquid cheese, the consumer may empty the food product into the container by squeezing the food product out of the food packaging product 2 into the container, as one would squeeze toothpaste out of a tube. The container may be a wide variety of containers, such as a bowl, pan, pot, skillet, drinking vessel, plate, and so on.

When the consumer has emptied the food product into the container, the consumer pours a liquid into the interior cavity of the food packaging product 2 such that a top surface of the liquid is approximately level with the fill line 10 (606). As the consumer is pouring the liquid into the interior cavity of the food packaging product 2, the consumer is able to determine that the top surface of liquid is approximately level with the fill line 10 because the fill line 10 is visible to the consumer when the consumer is looking into the internal cavity of the food packaging product 2. The fill line 10 may be visible to the consumer because the fill line 10 may be printed on a layer of the food packaging product 2 that is disposed such that no opaque layer of the food packaging product 2 is interposed between the layer and the interior cavity of the food packaging product. In the example of FIG. 3, the fill line 10 may be printed on an inner surface or an outer surface of the outer paper layer 300 because the intermediate plastic layer 302 and the inner plastic layer 304 are transparent or semi-transparent. In the example of FIG. 4, the fill line 10 may be printed on an inner surface or an outer surface of the inner plastic layer 406 or an inner surface of the metallic foil layer 404. In the example of FIG. 5, the fill line 10 may be printed on either the inner surface or the outer surface of any of the plastic layers 500, 502, or 504.

After the consumer pours the liquid into the interior cavity of the food packaging product 2, the consumer pours substantially all of the liquid out of the food packaging product 2 into the container, thereby creating a mixture of the liquid and the food product (608). In the example of FIG. 6, when the consumer has created the mixture of the liquid and the food product, the consumer may perform one or more additional steps to prepare the mixture for consumption (610). For example, the consumer may stir the mixture, heat the mixture, add additional ingredients to the mixture, add the mixture to another food product, or perform other steps to prepare the mixture for consumption. After the consumer has performed the additional steps to prepare the mixture for consumption, the consumer or another person may consume the mixture (612). For instance, the consumer may eat or drink the mixture as appropriate.

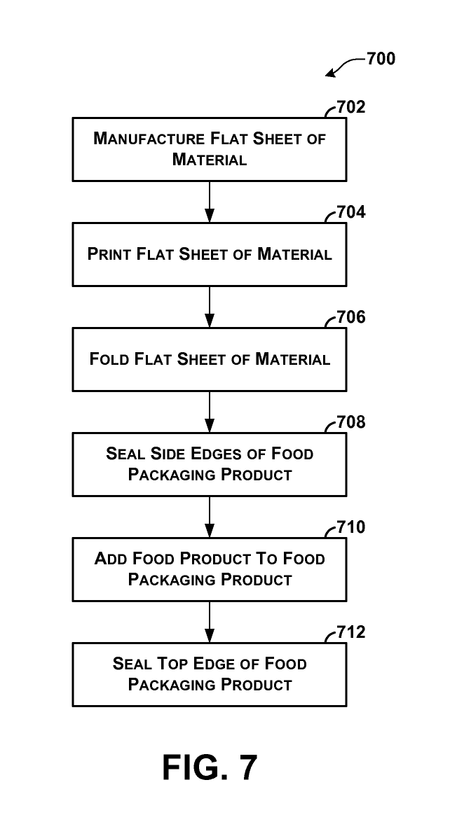

FIG. 7 illustrates an example process 700 of manufacturing the food packaging product 2. It should be understood that the process 700 is described for purposes of explanation only. Other processes of manufacturing the food packaging product 2 may be possible and within the scope of this disclosure. For instance, other processes of manufacturing the food packaging product 2 may involve more or fewer steps than process the 700. Furthermore, other processes of manufacturing the food packaging product 2 may involve the same steps as the process 700, but the steps may be performed in a different sequence. It should be understood that one or more of the steps of the process 700 may be performed by hand. In addition, it should be understood that one or more of the steps of the process 700 may be performed using a machine. For example, one or more of the steps of the process 700 may be automatically performed using a continuous motion horizontal form fill seal (HFFS) machine. In another example, the one or more of the steps of the process 700 may be automatically performed using a vertical form fill seal (VFFS) machine.

Initially, a manufacturer manufactures as a non-rigid, rectangular, flat sheet of material (702). For example, the manufacturer may manufacture a flat sheet of material that comprises an outer paper layer, an intermediate plastic layer, and an inner plastic layer as described in the example of FIG. 3. Depending on the material, the flat sheet of material may be at least partially-transparent. The flat sheet of material may have a width that is equal to the width of the finished food packaging product 2. In addition, the flat sheet of material may have a height that is approximately twice the height of the finished food packaging product 2. For example, if the finished food packaging product 2 is 3.125 inches wide and 7.00 inches high, the flat sheet of material may be 3.125 inches wide and 14.00 inches high. The manufacturer may manufacture the flat sheet of the material in many ways. In a first example, the manufacturer may manufacture a continuous roll of the material. In this first example, individual sheets of the material may subsequently be cut from the roll. In a second example, the manufacturer may manufacture individual separate sheets of the material.

After manufacturing the sheet of material, the manufacturer prints the flat sheet of material such that the fill line 10 is marked on the flat sheet of material (704). In addition, when the manufacturer prints the flat sheet of material, the tear line 8, the directions 16, and/or additional lettering or graphics may be marked on the flat sheet of material. It should be appreciated that in some example implementations, a different manufacturer may print the tear line 8, the fill line 10, the directions 16, and/or additional lettering or graphics on the sheet of the material. For example, a first manufacturer may create the sheet of material, print the marks on the sheet of material, and then provide the sheet of material to a second manufacturer. In this example, the second manufacturer may then perform the remaining steps of process 700.

Next, the manufacturer folds the flat sheet of material in half along a fold line perpendicular to the height axis 6 (706). When the manufacturer folds the flat sheet of material, the height of the sheet of material is reduced by half. For example, if the height of the flat sheet of material was 14.00 inches, the height of the folded sheet of material is 7.00 inches. The portion of the folded sheet of material to one side of the fold is the front member of the food packaging product 2 and the portion of the folded sheet of material to the other side of the fold is the rear member of the food packaging product 2.

After folding the sheet of material, the manufacturer seals the side edges of the front member to corresponding side edges of the rear member, forming the side edges 18 and 20 (FIG. 1) of the food packaging product 2 (708). In this way, the folded sheet of material forms an interior cavity that is open at the top edge 22 (FIG. 1) of the food packaging product 2. In one example, a HFFS machine includes two heated lands. In this example, the lands are spaced at a distance corresponding to the width of the food packaging product 2. As the food packaging product 2 moves through the HFFS machine, the lands heat the side edges of the food packaging product 2. When the lands heat the side edges of the food packaging product 2, the side edges of the front member bond to the corresponding side edges of the rear member, forming a seal.

Once the manufacturer has sealed the side edges 18 and 20 of the folded sheet of material, the manufacturer adds an appropriate amount of a food product into the interior cavity of the folded sheet of material (710). The manufacturer then seals the top edge of the front member to the top edge of the rear member, thereby sealing the top edge 22 of the finished food packaging product 2 (712). In this way, the food product is sealed within the food packaging product 2. The manufacturer may use a heated land to seal the top edge of the front member to the top edge of the rear member.

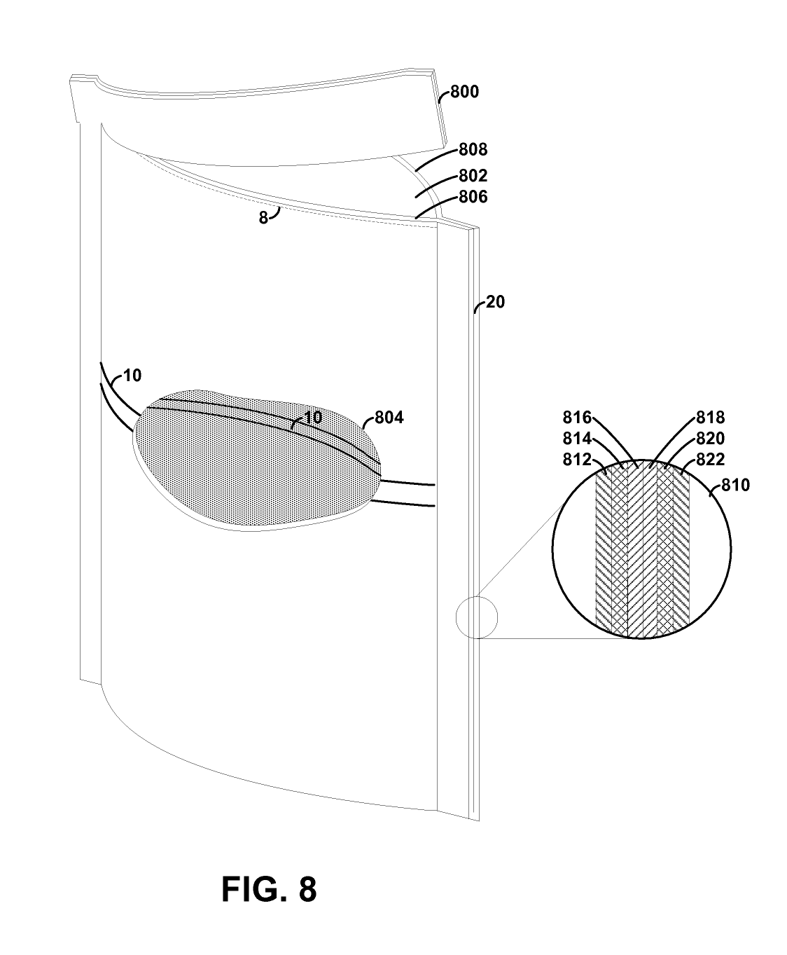

FIG. 8 illustrates a perspective view of the food packaging product 2. In the example of FIG. 8, the tear line 8 and the fill line 10 are visible on the food packaging product 2. For the sake of simplicity, directions 16 are not illustrated on the food packaging product 2 in the example of FIG. 8.

In the example of FIG. 8, the consumer has partially torn open the food packaging product 2 along the tear line 8. Because the consumer has only partially torn the food packaging product 2 open, a flap 800 remains attached to the food packaging product 2. It should be appreciated that the consumer could completely tear open the food packaging product 2 along the tear line 8, thereby removing flap 800. Because the consumer has opened the food packaging product 2, the interior cavity 802 of the food packaging product 2 is accessible.

For purposes of explanation, a hole 804 is shown in a first member 806 of the food packaging product 2. The hole 804 would not actually be present in the food packaging product 2, but is present in the example of FIG. 8 to show the inner surface of a second member 808 of the food packaging product 2. In the example of FIG. 8, the fill line 10 is marked on the first member 806 of the food packaging product 2 and the second member 808 of the food packaging product 2. Consequently, the fill line 10 is visible on the inner surface of the second member 808 of the food packaging product 2. It should be appreciated that the fill line 10 may also be visible on the inner surface of the first member 806 of the food packaging product 2. In other instances, the fill line 10 may only be marked on either the first member 806 or the second member 808 of the food packaging product 2. Because the fill line 10 is visible on the inner surface of the second member 808 of the food packaging product 2, the consumer is able to tell how much of the liquid to pour into the food packaging product 2 when the consumer is looking into the interior cavity 502 of the food packaging product 2.

The example of FIG. 8 also includes a blow-up area 810 that illustrates the side edge 20 in greater detail. As shown in the blow-up area 810, the side edge 20 consists of six layers 812, 814, 816, 818, 820, and 822. The layers 812, 814, and 816 are part of the first member 806 of the food packaging product 2 and the layers 818, 820, and 822 are part of the second member 808 of the food packaging product 2. The layer 816 of the first member 806 of the food packaging product 2 is sealed to the layer 818 of the second member 808 of the food packaging product 2. If the food packaging product 2 is constructed of the material illustrated in the example of FIG. 3, the layer 812 is paper, the layer 814 is plastic, the layer 816 is plastic, the layer 818 is plastic, the layer 820 is plastic, and the layer 822 is paper. If the food packaging product 2 is constructed of the material illustrated in the example of FIG. 4, each of the layers 812, 814, 816, 818, 820, and 822 is plastic. It should be appreciated that the blow-up area 810 is merely an example and that the food packaging product 2 may be constructed of a wide variety of other materials.

The technologies of this disclosure may be realized in many ways. For example, the technologies of this disclosure may be realized as a food packaging product that comprises a first member constructed of a substantially flat sheet of a non-rigid material, the first member having an inner surface, the non-rigid material being tearable, the non-rigid material providing a barrier against environmental elements, the non-rigid material being substantially impermeable to a liquid, and the non-rigid material not being intended for reuse. The food packaging product also comprises a second member constructed of a substantially flat sheet of the non-rigid material, the second member having an inner surface, the second member having substantially a same height and a same width as the first member. Each edge of the first member is attached to a corresponding edge of the second member. The first member and the second member define an interior cavity between the inner surface of the first member and the inner surface of the second member, the inner surface of the first member being a surface of the first member facing the second member and the inner surface of the second member being a surface of the second member facing the first member. The interior cavity contains a food product to which a consumer should add a recommended volume of the liquid prior to consumption of the food product, the recommended volume of the liquid being less than a volume of the interior cavity. A fill line is marked on the first member such that the fill line is visible to the consumer from inside the interior cavity after the consumer has substantially emptied the food product out of the interior cavity. The fill line is marked on the first member such that after the consumer has substantially emptied the food product out of the interior cavity and poured an amount of the liquid into the interior cavity such that a top surface of the liquid is substantially level with the fill line, the interior cavity contains the recommended volume of the liquid.

In another example, the technologies of this disclosure may be realized as a process of using a food packaging product. The process comprises receiving a rectangular flat sheet of material, the material being a non-rigid material, the material being tearable, the material providing a barrier against environmental elements, the material being substantially impermeable to a liquid, and the material not being intended for reuse. The food packaging product also comprises a second member constructed of a substantially flat sheet of the non-rigid material, the second member having substantially a same height and a same width as the first member. Each edge of the first member is attached to a corresponding edge of the second member. The first member and the second member define an interior cavity between an inner surface of the first member and an inner surface of the second member, the inner surface of the first member being a surface of the first member facing the second member and the inner surface of the second member being a surface of the second member facing the first member. The interior cavity contains a food product to which a consumer should add a recommended volume of the liquid prior to consumption of the food product, the recommended volume of the liquid being less than a volume of the interior cavity. A fill line is marked on the first member such that the fill line is visible to the consumer from inside the interior cavity after the consumer has substantially emptied the food product out of the interior cavity. The fill line is marked on the first member such that after the consumer has substantially emptied the food product out of the interior cavity and poured an amount of the liquid into the interior cavity such that a top surface of the liquid is substantially level with the fill line, the interior cavity contains the recommended volume of the liquid. The process further comprises opening the food packaging product by tearing the food packaging product along a tear line visibly marked on the first member or the second member. In addition, the process comprises after opening the food packaging product, emptying the food product out of the interior cavity of the food packaging product into a container. Furthermore, the process comprises after emptying the food product out of the interior cavity into the container, pouring the liquid into the interior cavity until a top surface of the liquid within the interior cavity is substantially level with the fill line. The addition, the process comprises after pouring the liquid into the interior cavity, pouring the liquid out of the interior cavity into the container, thereby creating a mixture of the food product and the liquid.

In another example, the technologies of this disclosure may be realized as a process of manufacturing a food packaging product. The process comprises folding a flat sheet of material in half along a fold line, the flat sheet of material being rectangular, the material being a non-rigid material, the material being tearable, the material providing a barrier against environmental elements, the material being substantially impermeable to a liquid, the material not being intended for reuse, a fill line being visibly marked on the flat sheet of material, the fold line being perpendicular to a height axis of the food packaging product, thereby creating a folded sheet of material that has half the length of the flat sheet of material, the portion to one side of the fold line forming a first member and the portion to an opposite side of the fold line forming a second member. Furthermore, the process comprises after folding the flat sheet of material, sealing a first side edge of the first member to a first corresponding edge of the second member. In addition, the process comprises after folding the flat sheet of material, sealing a second side edge of the second member to a second corresponding edge of the second member, thereby forming an interior cavity between an inner surface of the first member and an inner surface of the second member, the inner surface of the first member being a surface of the first member facing the second member and the inner surface of the second member being a surface of the second member facing the first member. The process also comprises after sealing the first side edge of the first member to the first corresponding edge of the second member and after sealing the second side edge of the second member to the second corresponding edge of the second member, adding into the interior cavity a food product to which a consumer should add a recommended volume of the liquid prior to consumption of the food product, the recommended volume of the liquid being less than a volume of the interior cavity. The fill line is visible to the consumer when the consumer is looking into the interior cavity. When the consumer adds the recommended volume of the liquid to the interior cavity after the food product is emptied out of the interior cavity, a top surface of the liquid within the interior cavity is substantially level with the fill line. The process also comprises after adding the food product, sealing a top edge of the first member to a top edge of the second member, thereby sealing the food product within the interior cavity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A process of using a food package, the process comprising:
opening the food package at a tear line, the food package including a non-rigid material being substantially impermeable to a liquid and forming an interior cavity in which instant oatmeal is stored;
emptying the instant oatmeal into a bowl;
pouring water or milk into the food package to a ⅔ cup fill line on the food package; and
pouring the water or milk into the bowl with the instant oatmeal.

2. The process of claim 1, further comprising heating the instant oatmeal.

3. The process of claim 1, wherein the fill line is visible on an interior surface of the food package.

4. The process of claim 3, wherein the fill line is printed on an outer surface of the food package.

5. The process of claim 3, wherein the food package is at least partially transparent.

6. A process of using a food package, the process comprising:
tearing open the food package;
emptying a food contents of the food package into a bowl;
using the food package to measure an amount of liquid needed by filing a liquid to a fill line on the food package;
pouring the liquid into the bowl; and
heating the food contents.

7. The process of claim 6, wherein the food contents is instant oatmeal.

8. The process of claim 6, wherein the liquid is water or milk.

9. The process of claim 6, wherein tearing open the food package further comprises tearing open the food package at a tear line.

10. The process of claim 6, wherein the fill line is visible on an interior surface of the food package.

11. The process of claim 10, wherein the fill line is printed on an outer surface of the food package.

12. The process of claim 10, wherein the food package is at least partially transparent.

13. The process of claim 6, wherein the food package is includes a non-rigid material being substantially impermeable to the liquid and forming an interior cavity in which the food contents is stored.

14. A process of using a food packaging product, the process comprising:
opening the food packaging product;
after opening the food packaging product, emptying a food product out of the food packaging product and into a container;
after emptying the food product out of the food packaging product, pouring a liquid into the food packaging product until a top surface of the liquid within the food packaging product is substantially level with a fill line on the food packaging product; and
after pouring the liquid into the food packaging product, emptying the liquid out of the food packaging product into the container.

15. The process of claim 14, wherein the fill line is printed on the food packaging product.

16. The process of claim 15, wherein the fill line is visible on an interior surface of the food packaging product.

17. The process of claim 16, wherein the food packaging product is at least partially transparent.

18. The process of claim 17, wherein the food product is oatmeal.

19. The process of claim 14, wherein the food product is oatmeal.

20. The process of claim 14, wherein the food product is a drink mix.
